(19) United States
(12) Patent Application Publication
(10) Pub. No.: US 2026/0262578 A1
(43) Pub. Date: Sep. 10, 2026

(54) VERTICALLY-INTEGRATED COMBINED FARMING AND FOOD-DISTRIBUTION SYSTEM AND METHOD

(71) Applicant: David Lynton JEPHCOTT, Stoke-on-Trent (GB)

(72) Inventor: David Lynton JEPHCOTT, Stoke-on-Trent (GB)

(21) Appl. No.: 18/728,546

(22) PCT Filed: Nov. 10, 2022
(86) PCT No.: PCT/GB2022/052854

§ 371 Date: Jul. 12, 2024

(30) Foreign Application Priority Data
Nov. 12, 2021 (GB) 2116356.3

(51) Int. Cl. A01G 9/14; A01G 9/24; A01K 63/00

(52) U.S. Cl. CPC A01G 9/143; A01G 9/243; A01G 9/247; A01G 9/249; A01K 63/003

(57) ABSTRACT

A vertically-integrated combined farming and food-distribution system (10) is provided for producing and distributing food which is grown and/or raised wholly beneath a surface of ground and/or of a body of water. The system (10) comprises a below-surface food-production assembly (14) for producing food. The below-surface food-production assembly (14) has a protective shell (16) which is locatable at least partly below the surface and food-producing infrastructure (18). The food-producing infrastructure (18) is positioned within the protective shell (16) for growing or raising an edible product. The food-producing infrastructure includes a product-growing support for supporting and enabling the growth of the edible product thereat, an artificial lighting sub-system (48b) positionable at or adjacent the product-growing support for illuminating the edible product, and a fluid-distribution sub-system (48d). The fluid-distribution sub-system (48d) has a fluid-storage chamber (46), and at least one fluid conduit (60b). The at least one fluid conduit (60b) connects the fluid-storage chamber (46) to the product-growing support for providing fluid to the product-growing support. The system (10) further comprises an above-surface distribution centre (12a) and an access (29). The above-surface distribution centre (12a) enables the distribution the food produced by the below-surface food-production assembly (14). The above-surface distribution centre (12a) overlies the below-surface food-production assembly (14) which provides a foundation therefor. The access (29) between the below-surface food-production assembly (14) and the above-surface distribution centre (12a) allows the movement of the edible product therebetween.

The present invention relates to a combined farming and food-distribution system which enables production and distribution of food which is grown and/or reared, preferably wholly, underground and/or underwater. The present invention also pertains to a method for improving land-usage efficiency, increasing food freshness and reducing pollution due to transport of food.

Climate change is threatening food security. Natural disasters such as droughts, heat-waves, floods, fires, high winds, storms and land movements such as due to earthquakes and landslides are becoming increasingly common. These natural disasters, together with increasingly unpredictable weather patterns, result in poor yields and/or failed harvests.

Soil erosion, water availability, loss of pollinating insect biodiversity, biological weapons, disease and pests are further factors threatening food security. Arable land is rapidly disappearing yet currently large swathes of land are required to grow crops. Clearing woodlands is seen as a solution to increase the available arable land, but deforestation further contributes to climate change.

An existing solution to the land-use problems is vertical farming which involves a greater yield per square-metre, due to growing crops vertically. The land-use is therefore more efficient. Vertical farming may even be done indoors, such as in large greenhouses, to have a greater control over factors influencing plant growth such as water, light, temperature and nutrients. However, these buildings are easily destroyed by natural disasters such that food security is not assured.

Bringing food from the site of production to the consumer requires transport over large distances, and is usually carried out by locomotion means relying on fossil-fuels. Furthermore, due to the distances to be travelled and the time lag between produce being harvested and reaching the customer, demand for a product in the future must be estimated. Food is then harvested ahead of time in order to meet the estimated demand at the relevant point in time. If the supply exceeds the actual demand, food may be wasted. If the supply is less than the actual demand, there is a shortage of food. Food can also spoil during transport. As such, food transport and food wastage also contribute to climate change.

The present invention seeks to provide a solution to these problems.

According to a first aspect of the present invention, there is provided a vertically-integrated combined farming and food-distribution system for producing and distributing food which is grown and/or raised wholly beneath a surface of ground and/or of a body of water, the system comprising: a below-surface food-production assembly for producing food and having: a protective shell which is locatable at least partly below the surface; food-producing infrastructure positioned within the protective shell for growing or raising an edible product, the food-producing infrastructure including: a product-growing support for supporting and enabling the growth of the edible product thereat, an artificial lighting sub-system positionable at or adjacent the product-growing support for illuminating the edible product, and a fluid-distribution sub-system having a fluid-storage chamber, and at least one fluid conduit connecting the fluid-storage chamber to the product-growing support for providing fluid thereto; and an above-surface distribution centre for distributing the food produced by the below-surface food-production assembly, the above-surface distribution centre overlying the below-surface food-production assembly which provides a foundation therefor; and an access between the below-surface food-production assembly and the above-surface distribution centre for allowing the movement of the edible product therebetween. The farming and food-distribution system increases food security by enabling an edible product, such as plants, animals, or any part thereof to be produced underground and/or underwater. The underground or underwater production means that the food-producing facilities are sheltered from the elements and/or natural disasters. By providing a distribution centre adjacent to and preferably above the food-producing facilities, the distance travelled by food may be reduced. This may reduce pollution due to transporting food. The freshness of the produce may also be increased. As the distribution centre is preferably directly above the below-surface food-production assembly such that they share at least in part the same footprint, the land use is more efficient.

Preferably, the protective shell and/or the above-surface distribution centre may further comprise a roof, at least part of the roof being moveable between an open condition and a closed condition, for facilitating the access to an internal space of the protective shell and/or the above-surface distribution centre. The moveable roof provides an access which may enable distances travelled by food to be reduced further as food may be movable vertically. Additionally or alternatively, by having the access within the above-surface distribution centre, the centre may provide a further barrier against the elements. The centre may also provide better control of the access to the below-surface food-production assembly. This may reduce the chances of accidental or deliberate contamination, for example. Unauthorised access may be prevented or inhibited. Having an openable roof portion may further facilitate the movement of goods out of the system, such as by being airlifted from the distribution centre.

Beneficially, the fluid-storage chamber may include an aquaculture fluid-storage chamber for storing fluid as well as supporting aquatic life therein for providing an aquaponic food-producing infrastructure. An aquaponic food-producing infrastructure enables animal waste to be used to fertilise at least one plant. Simultaneously, aquatic life, such as fish, may be reared. This may further increase the amount of food produced by the system. Additionally, by providing a fluid-storage chamber fulfilling multiple functions simultaneously, the use of space within the below-surface food-production assembly is more efficient, compared to having a plurality of fluid-storage chambers, each fulfilling one function only.

Advantageously, the system may further comprise at least one solar panel for capturing solar energy to power the farming and food-distribution system. Optionally, at least one said solar panel may comprise a perovskite structure. Solar-derived energy is environmentally friendly. A perovskite structure may increase the yield of energy.

Furthermore, the system may comprise food-moving infrastructure which includes at least one of: a lift and a conveyor sub-system. Food may be easily moved through the system, during growth and/or after being harvested.

Optionally, the conveyor sub-system may include a guiding portion and at least one, and preferably a plurality of movable carriages. Furthermore, the movable carriages may be moveable under compression along the guiding portion. Conveyor belts and chains which moved under tension may stretch and/or tear whereas compression avoids these issues.

Beneficially, at least one of the movable carriages may include an identifier for enabling a movable carriage, and any item associated therewith, to be trackable. Tracking of information associated with a food item may be automated. The information may include, by way of example only, position within the system, species, planting date, age, height, harvest date, or any other valuable information.

Advantageously, the system may further comprise a heat pump. The heat pump may be a ground source heat pump, an air source heat pump, a water source heat pump, a pump for any alternative source of heat, or any combination thereof. Heat pumps are highly energetically-efficient devices for regulating temperature of a volume, thus are environmentally friendly. As heat pumps are typically reversible, the heat pump can both cool and heat a volume, as required. If a heat pump is provided, there is no need for providing a dedicated cooling system and a dedicated heating system. This may save space and/or costs.

Beneficially, the system may include water purification means. Optionally, the water purification means may include water desalination means for desalinating salt water. Water purification means may enable waste, contaminants and/or pathogens to be removed from water, for example, to provide potable water. If the system is provided in, on or next to a body of salt water such as a sea, fresh water may be created from the salt water.

Additionally, the below-surface food-production assembly may further comprise infrastructure for genetically altering an organism. Infrastructure for genetically altering an organism, such as an underground laboratory, may enable genetic manipulation to be carried out. Genetic alteration may improve yields, improve nutritional qualities, breed pathogen and/or pest resistance, produce a pharmaceutical compound, by way of example only.

Optionally, the infrastructure for genetically altering an organism may further comprise vaccine-production infrastructure for creating and growing plants inoculated to produce a substance for a vaccine against a non-plant disease. Plants may be used to generate one or more pharmaceutical compounds. The one or more compounds may be used to produce vaccines against plant and/or non-plant diseases. Plant-based manufacturing of compounds may reduce or eliminate the need for animal-derived manufacturing of compounds, such as chicken eggs.

Preferably, the system may further comprise an automated food harvesting element for automatically harvesting food. Additionally or alternatively, the system may include a growth-monitoring element for monitoring the growth of a plant and/or animal. Monitoring and/or harvesting may be automated, thereby reducing the size of the human workforce required. As a robotic device can continuously monitor and/or harvest food, the harvesting speed and/or efficiency may be increased, thereby reducing costs. Furthermore, automated harvesting and monitoring may negate the need to provide an access for a human to monitor and/or harvest. In turn, more food can be grown in a given volume, further improving the food-production efficiency. Beneficially, the system may further comprise environmental buffering means for providing a buffer against the environment. Furthermore, the system may further comprise natural disaster protection means for providing protection against extreme weather and/or a natural disaster. The environmental buffering means, and natural disaster protection means, which is preferably part of the environmental buffering means, provide protection against a range of environmental conditions.

Optionally, the natural disaster protection means may include flood-proofing means for preventing or inhibiting flooding of the farming and food-distribution system. Additionally or alternatively, the natural disaster protection means may include fire-proofing means for preventing or inhibiting fire in the farming and food-distribution system. Optionally, the natural disaster protection means may include a wind-redirecting element for redirecting wind to prevent or inhibit damage to the farming and food-distribution system due to strong winds. Furthermore, the natural disaster protection means may include land movement-proofing means for preventing or inhibiting damage to the farming and food-distribution system due to land movements. Optionally, the land movement-proofing means may include at least one of: a cage element, a flexible foundation, a damping element, a vibration-controlling element, a reinforcing element, and earthquake-resistant materials. Food may continue to be produced despite natural disasters such as a fire, a flood, a storm, or an earthquake, by way of example.

Preferably, the system may further comprise means for preventing or inhibiting contamination by a contaminant and/or pathogen of the below-surface food-production assembly or part thereof. Optionally, the means for preventing or inhibiting contamination comprises at least one of: a disinfection zone, an airlock, a partitioning element, netting, a membrane, a vacuum, a pressurised chamber, a pathogen destroying element, a pathogen capturing element, a pollen-trapping element, a pollen-destroying element, and an air-moving element for preventing or inhibiting genetic contamination of the edible product.

Pests and/or pathogens, whether natural or a biological weapon, may threaten food security, particularly if no pesticides are used within the system. Preventing or inhibiting the ingress of pests and/or pathogens into the system and/or the below-surface food-production assembly may reduce this risk. If there is an outbreak within the system, the means for preventing or inhibiting contamination by a contaminant and/or pathogen may enable the spread of the contaminant and/or pathogen to be restricted. If genetic manipulation is carried out within the system, preventing or inhibiting genetic contamination may be desirable, for example, by preventing or inhibiting pollen of genetically modified or edited plants from pollinating non-genetically modified or edited plants, or vice-versa.

Preferably, the below-surface food-production assembly may further comprise a pollination sub-system for enabling pollination of the plant. Furthermore, the pollination sub-system may comprise an insect-housing means for housing an insect species for increasing biodiversity and/or enabling pollination of insect-pollinated crops. Additionally or alternatively, the pollination sub-system may comprise an air-moving means for moving air to enable pollination of wind-pollinated crops in the protective shell. The pollination sub-system may enable or facilitate pollination. Some crops may require pollination by a pollinator, such as an insect, bird, bat or other pollinator species. Other crops, such as maize or rice, are pollinated by wind. Advantageously, the vertically-integrated combined farming and food-distribution system may be provided as a kit of parts. Manufacturing and/or transport of components of the system may be facilitated.

According to a second aspect of the invention, there is provided a method for simultaneously increasing food freshness and reducing pollution due to transport by reducing a distance travelable by food from a food-production site to a food-distribution centre, the method comprising the steps of: a] creating or repurposing a cavity in the ground and/or in a body of water; b] creating and positioning in the cavity a protective shell and installing food-producing infrastructure in the protective shell for providing a below-surface food-production assembly for producing food below a surface of the ground and/or of the body of water; and c] creating an above-surface distribution centre preferably overlying the below-surface food-production assembly and communicable with the below-surface assembly for minimising time and distance travelled by food produced by the below-surface food-production assembly.

The above-surface distribution centre preferably at least in part vertically overlaps or overlies the below-surface food-production assembly, but non-overlying may be an option. By sharing the same footprint, distance travelled by food at least horizontally from the food-production assembly to the distribution centre can be reduced. Pollution may also be reduced, such that the method of producing and distributing food is environmentally friendly. Due to the reduced distance, produce may be fresher and/or the risk of food spoiling is reduced. Food may also be harvested upon or substantially upon request to meet demand in real time or substantially real time, due to the short distances and therefore short period of time between harvesting and distribution.

Furthermore, existing cavities and/or existing infrastructure may be repurposed, which may reduce costs. Repurposing cavities and/or existing buildings, such as a bunker, may improve the land-usage as removing the need to create a further building. Optionally, in step b], the protective shell may be created by positioning a frame in the cavity and spraying a building material onto and/or into the frame. The protective shell may be custom-built in situ.

Alternatively or additionally, in step b], the protective shell may be formed prior to insertion into the cavity. The protective shell may be formed at least in part elsewhere, for example, in a factory, before being transported to the desired location. The ease of manufacturing may be increased, and this may result in a reduction of costs.

Optionally, step b] may further comprise providing a secondary lining on the shell of the building for aquaponics. The lining may provide a fluid-proof barrier. This may prevent or inhibit fluid from within the system from entering into the protective shell. Additionally or alternatively, the lining may prevent or inhibit fluid from outside the system from entering the system and/or an internal volume thereof.

The invention will now be more particularly described, by way of example only, with reference to the accompanying drawings, in which:

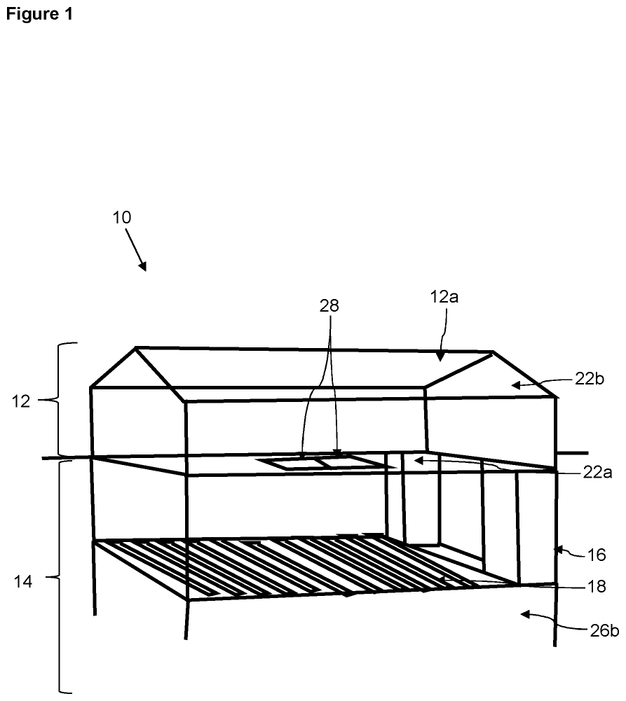

FIG. 1 shows a perspective representation of part of an embodiment of a farming and food-distribution system in accordance with the first aspect of the invention, with solar panels, part of the below-surface food-production assembly and the infrastructure for genetically altering an organism omitted for clarity, and with floors and walls of the farming and food-distribution system together with the ground shown in transparency for clarity;

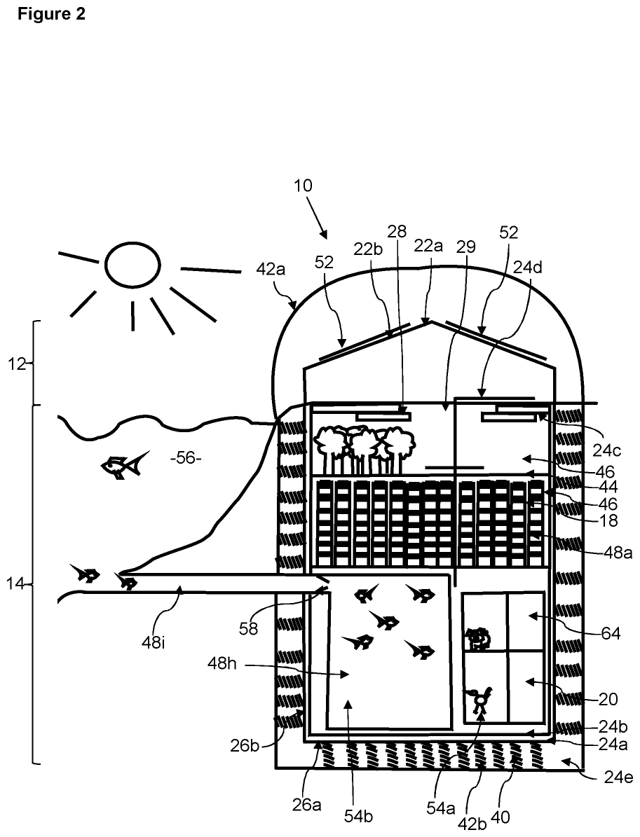

FIG. 2 is a cut-away side representation of the farming and food-distribution system of FIG. 1;

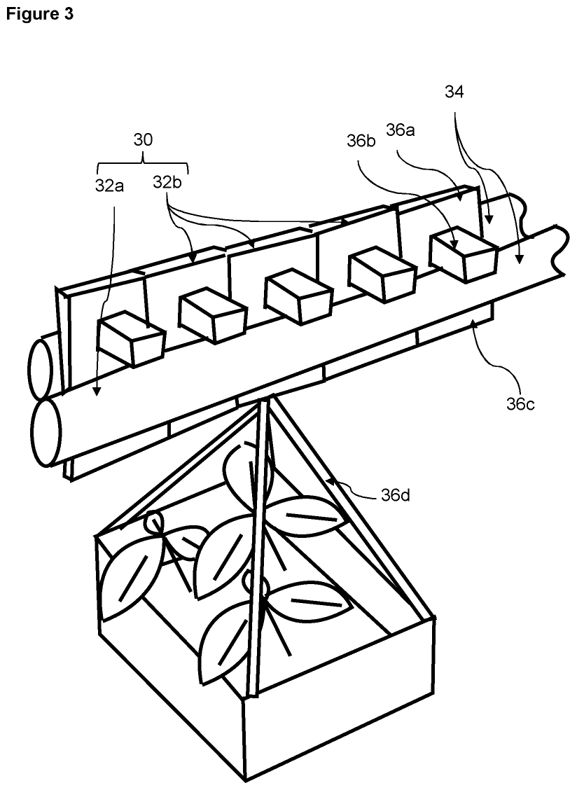

FIG. 3 illustrates a close-up partial perspective view of a first embodiment of a food-moving infrastructure of the farming and food-distribution system of FIG. 1;

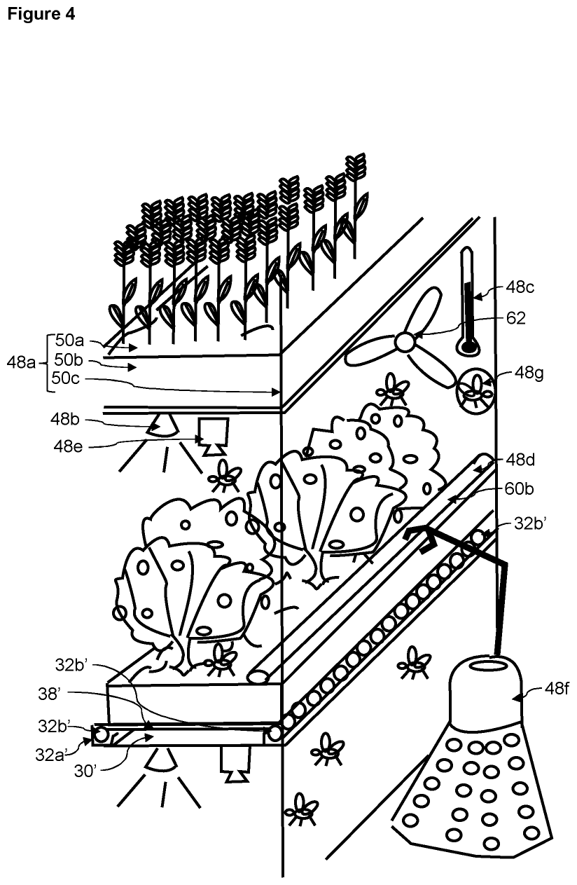

FIG. 4 illustrates a close-up partial perspective view of food-producing infrastructure of the farming and food-distribution system of FIG. 1, including a second embodiment of a food-moving infrastructure;

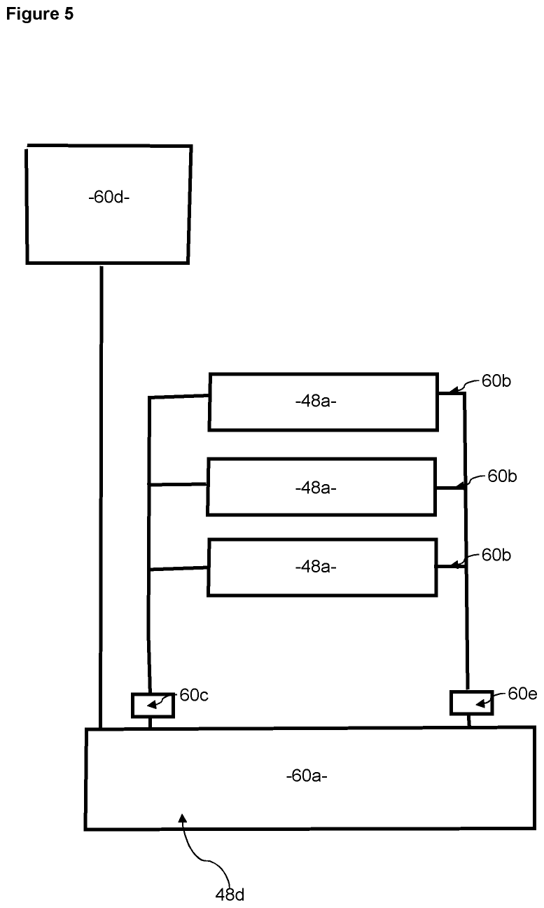

FIG. 5 is a schematic representation of a fluid-distribution sub-system of the farming and food-distribution system of FIG. 1; and

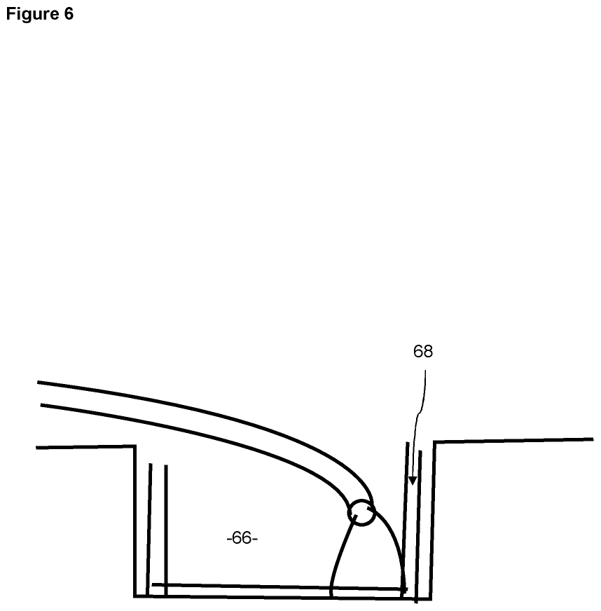

FIG. 6 shows cement being poured into a frame in a cavity in the ground in accordance with the second aspect of the invention.

Referring firstly to FIG. 1, there is shown a farming and food-distribution system indicated generally at 10. The farming and food-distribution system 10 in-use at least produces at least one edible product. Preferably, the farming and food-distribution system 10 produces food which is grown at least in part, and preferably fully underground, although above-ground may be an option. The term “ground” used herein and throughout is intended to mean the substrate in which the below-surface food-production assembly is embedded or received. The term “ground” is not intended to be limited to earth or soil, and may encompass other media, such as sand, permafrost, ice, or rock. The medium may be terrestrial, or extra-terrestrial, such as a lunar or a Martian medium. A synonym of “ground” may be “land”.

For clarity, the term “growth medium” will be used to distinguish from the term “ground” and is intended to refer to the substrate within which an organism can grow. In the case of a plant, the growth medium is the substrate within which plants extend a network of roots at least.

Thus, a majority of and preferably the whole organism, such as a plant or animal, is preferably grown or reared below a surface of the ground. Additionally, all or only part of a plant may grow beneath a surface of the growth medium.

In a slight modification, the farming and food-distribution system 10 or part thereof may be at least partially sunk into a body of water. In this alternatively, the farming and food-distribution system produces food which is grown at least in part, and preferably fully below the surface of the body of water. It may even be envisioned that part of the farming and food-distribution system may be underwater, whilst another part of the system may be on land.

Optionally, the farming and food-distribution system 10 may enable distribution of food, and more preferably of food produced by the farming and food-distribution system. The farming and food-distribution system 10 comprises an above-surface assembly 12 and a below-surface assembly 14, but either feature may be omitted and/or a plurality of either may be provided. Preferably, an access therebetween is provided but this is optional. The farming and food-distribution system 10 or any part thereof may include plastics, metal, wood, magnetic material, concrete, cement, fibreglass, carbon fibre, any other suitable material, or any combination thereof.

The above-surface assembly 12 preferably includes a distribution centre or module 12a, but this feature may be omitted and/or a plurality may be provided. The above-surface assembly 12 may therefore be referred to as an above-surface distribution centre or an above-ground distribution centre 12a.

The below-surface assembly or below-ground assembly 14 is preferably at least in part below the surface of the ground and/or below a surface of a body of water. The below-surface assembly 14 includes a protective shell 16, food-producing infrastructure 18 and infrastructure for genetically altering an organism, but any of these features may be omitted and/or a plurality may be provided. Optionally, the infrastructure for genetically altering an organism may include pharmaceutical-production infrastructure 20, but this is optional.

The above-surface assembly 12 and/or distribution centre 12a thereof in-use enables food distribution. The distribution centre 12a preferably includes a building, such that the distribution centre 12a may be referred to as a distribution building. The distribution centre 12a is at least partly, and more preferably fully above the surface of ground and/or the surface of a body of water. The distribution centre 12a is associated with the protective shell 16. More preferably, the distribution centre 12a is positioned adjacent to or at the protective shell 16. As shown, the distribution centre 12a at least partly, and preferably fully overlies or overlaps with the protective shell 16. In other words, the distribution centre 12a is positioned or located above the protective shell 16. The above-surface assembly 12 and the below-surface assembly 14 are therefore vertically integrated. This reduces distance that food needs to travel from the production site to the distribution site. Optionally, the protective shell and the distribution centre 12a may form a single or unitary structure as shown. The distribution centre 12a has a distribution-centre floor 22a and a distribution-centre roof 22b.

The protective shell 16 in-use receives and/or houses the food-producing infrastructure 18 and/or the infrastructure for genetically altering an organism. The protective shell 16 is at least partly, and more preferably, is fully below the surface of the ground and/or of water, for a more efficient land-use and/or for an increased protection or insulation against the effects of climate change. The protective shell 16 has a shell structure 24a, a secondary lining 24b, a protective shell roof 24c, food-moving infrastructure 24d, and an environmental buffering means 24e, but any of these features may be omitted and/or a plurality of any of these features may be provided.

The shell structure 24a includes a protective shell floor 26a and one or more protective shell walls 26b. The shell structure 24a defines an internal volume. The protective shell walls 26b preferably extend upwardly or generally upwardly from the protective shell floor 26a, and more preferably from the periphery of the protective shell floor 26a. Thus, the shell structure 24a is preferably an outer shell. The walls 26b may extend vertically upwards. However, depending on the nature of the ground, one or more walls 26b may extend at an angle, for example, to prevent or inhibit caving in of the ground. Relative to a vertical, such an angle may be at least 2°, and more preferably is at least 5°, although less than 2° may be an option. Even more preferably, the angle may be at least 10° and more preferably at least 20°. The angle may even be 30°. The secondary lining 24b, if provided, is positioned on an inward-facing surface of the shell structure 24a, but an outward-facing surface and/or within the walls 26b may be an option.

The protective shell roof 24c is an upper surface or wall of the protective shell 16. The shell roof 24c may in-use provide a protection against the above-surface environment and/or may support ground or water, depending on how deep the shell roof 24c is relative to the surface. The shell roof 24c may be at, below or above the surface. The above-surface assembly 12 may be omitted, vertically spaced apart from or only partially overlies the below-surface assembly 14, and more preferably the shell roof 24c. Optionally, at least part of the shell roof 24c may be transparent or translucent. This may enable natural light to penetrate into the below-surface assembly 14. In this case, artificial light may be entirely optional.

If the above-surface assembly 12 and/or distribution centre 12a shares at least some of the footprint of the protective shell 16, the shell roof 24c may be a transition or barrier between the protective shell 16 and the above-surface assembly 12. The shell roof 24c may even be considered to be a ceiling. Optionally, the protective shell roof 24c and the distribution-centre floor 22a may be one and the same.

At least one of: the protective shell roof 24c and the distribution-centre roof 22b has at least one movable roof portion 28, but the movable roof portion may be omitted. For example, the whole of the protective shell roof and the distribution-centre roof may be non-movable or fixed. The movable roof portion 28 in-use selectively opens or closes an aperture 29 in the relevant roof. The aperture 29 may provide the said access between the above-surface assembly 12 and the below-surface assembly 14. Thus, at least part of the roof may be moveable between an open condition and a closed condition. The movable roof portion 28 and the aperture 29 it selectively opens and close, may facilitate the access to an internal space of the protective shell 16 and/or the above-surface distribution centre 12a. This may, for example, enable food to be moved therethrough.

The movable roof portion 28 may be entirely removeable. Alternatively or additionally, the movable roof portion 28 may be moved, such as by being pivotable and/or slidable. The movable roof portion 28 may thus be retractable. In a further embodiment, the movable roof portion 28 may even be deformable. A plurality of movable roof portions 28 may even co-operate together to selectively open and close the aperture 29.

If the protective shell roof 24c and the distribution-centre floor 22a are one and the same, a movable roof portion 28 may be provided in the protective shell roof 24c which provides a closeable access between the protective shell 16 and the distribution centre 12a.

The food-moving infrastructure 24d in-use enables food to be moved around the farming and food-distribution system 10. The food may be moved at any stage of food production, such as during growth and/or following harvesting. By providing food-moving infrastructure, transporting food may be facilitated through any of: the above-surface assembly 12, the below-surface assembly 14, from the below-surface assembly 14 to the above-surface assembly 12, and vice-versa. Furthermore, if user access to plants such as a walkway can be omitted, a greater number of plants can be grown in a given space, increasing space usage efficiency.

The food-moving infrastructure 24d may include any of: a lift, a conveyor sub-system, a robotic arm, a robot, any other suitable means or mechanism for moving food, a plurality of any of the above, and any combination of the above. In the case of a conveyor sub-system, the conveyor sub-system may include at least one conveyor belt. The conveyor belt may enable movement of an item placed thereupon, similarly to the second embodiment. The conveyor belt may include any of: a movable carpet, movable carpet sections, a rotatable cylinder, a bead, any other suitable mechanism or means for moving an item, a plurality of any of the above, and any combination thereof.

A first embodiment of a conveyor sub-system 30 is shown in FIG. 3. The conveyor sub-system 30 may include at least one guiding portion 32a, at least one movable carriage 32b, and a driver member, but a plurality of any of the above features may be provided and/or any of the above features may be omitted.

The at least one movable carriage or movable support 32b may be engageable with and movable along the guiding portion or portions 32a. In a preferred embodiment, the conveyor sub-system 30 comprises a, preferably linear, train of movable carriages 32b. The train of movable carriages 32b may be overhead and/or below an item to be moved. A train of movable carriages 32b above an item to be moved may be referred to as a overhead conveyor. A train of movable carriages 32b below an item to be moved may be referred to as a flatbed conveyor.

At least one, and preferably each movable carriage 32b may be movable forward and/or backward with at least one, and preferably all other movable carriages 32b. Preferably the movable carriages 32b are placed in compression as opposed to the tensile transmission used in chain and belt drive conveyors. In other words, a movable carriage 32b is pushed along the guiding portion 32a. The, each or at least one movable carriage 32b preferably includes plastics and/or metal, but any alternative material may be an option. Each movable carriage 32b may be moved by the driver member and/or by an adjacent movable carriage 32b.

The driver member, not shown, may engage with at least one movable carriage 32b and cause the at least one movable carriage 32b to move either forward or in reverse. The driver member may include a star wheel, a drive screw or any other arrangement which may impart, preferably linear, motion to the movable carriage 32b. The driver member may optionally further comprise an energisable motor. The driver member may be provided in or on a said movable carriage but preferably is associated with the or a said guiding portion 32a.

The guiding portion 32a may include at least one, and as shown two rails 34. The guiding portion 32a may also be referred to as a constraining portion. It may easily be envisioned that at least three rails may be provided, extending parallel or substantially parallel and in a general pattern relative to each other to form a channel in and/or on which a said movable carriage or part thereof is receivable. A closed or substantially closed channel may even be envisioned.

At least one, and preferably a plurality of movable carriages 32b are translatable relative to the guiding portion 32a. The, each or at least one said movable carriage 32b comprises a carriage body 36a, at least one protrusion 36b, an identifier 36c and suspension means, 36d, but any of these features may be omitted and/or a plurality of any of the features may be provided.

The movable carriage 32b and/or the carriage body 36a are here shown as a cuboid. However, any non-cuboid may be envisioned. For instance, the movable carriage and: or the carriage body may include a sphere, a spheroid, a cylinder, an ovoid, a bead, or have any polygonal or non-polygonal shape in cross-section. A plurality of such movable carriages may be referred to as a “Bead Drive”. Beads in the drive system could be hollow and therefore capable of carrying and dispensing liquids or dry compounds to deliver nutrients or water or other liquid organic fertilizer or immunology substances into selected plants.

Here there are preferably two protrusions 36b. The protrusions 36b extend in opposite directions to each other from the carriage body 36a. As shown, each protrusion 36b is engageable with the guiding portion 32a. The protrusions 36b are preferably slidable along the guiding portion 32a, but any non-slidable engagement may be envisioned. Each protrusion 36b is seatable on the guiding portion 32a here, but may be non-seatable, such as by being at least partly receivable in, on, below or around a guiding portion or rail thereof. A protrusion may even be replaced by a groove in a further modification.

In a slightly modified embodiment, the, each or at least one protrusion may comprise a wheel or wheel element, such that the carriage may be rollable along the guiding portion.

The movable carriage may even have no protrusions. For example, a dimension of the movable carriage and/or carriage body may be greater than a distance of a gap between two rails such that the dimension of the movable carriage may prevent or inhibit the movable carriage from falling through the gap.

The identifier 36c in-use provides each movable carriage 32b with a unique identity. The identifier 36c is at, in, or on the movable carriage 32b, and more preferably the carriage body 36a. Optionally, the identifier 36c may be embedded or embeddable into any part of the movable carriage 32b. The identifier 36c may include any of: a visual identifier 36c, a chip, a Radio frequency Tag, any other suitable identification element, part or portion, a plurality of any of the above, and any combination thereof. The visual identifier 36c may include any of: a colour, a pattern, a symbol, an image, a bar code, a qr code, any other suitable visual identifier, a plurality of any of the above, and any combination thereof. A visual identifier 36c may enable the movement of goods to also be monitored via simple optic readers.

In the case of a Radio Frequency Tag or RFID, the or each RFID can be configured to read and/or write data. The RFID tag may be configured to capture and carry data. Optionally, the or each RFID tag may be capable of being wiped clean of data and used many times over again. This may enable the movement of goods to be monitored via an RFID reader which may interrogate the individual read/write tags embedded in each movable carriage 32b.

The suspension means, suspension part, or suspension 36d in-use enables an item to be suspended from the movable carriage 32b. In the illustrated embodiment, the item may be part of the food-producing infrastructure 18 and/or at least one organism, illustrated here are plants. Thus, the conveyor sub-system 30 may be referred to as an overhead conveyor sub-system 30. A second embodiment of a conveyor sub-system 30′ is shown in FIG. 4. It may be that either or both embodiments of conveyor sub-systems may be provided within the same farming and food-distribution system.

Similarly to the first embodiment, the conveyor sub-system 30′ includes at least one guiding portion 32a′ and at least one movable carriage 32b′, the movable carriage 32b′ having a carriage body and optionally an identifier. The movable carriages 32b′ are movable under compression. Detailed description of the common features is omitted for brevity. Preferably, the suspension means and/or the at least one protrusion are omitted, but either or both features could easily be envisioned in the second embodiment of the conveyor sub-system 30′.

Preferably, the movable carriages 32b′ are provided in pairs. Each movable carriage 32b′ of a pair is preferably guided or constrained in a different guiding portion 32a′. Preferably, in the second embodiment, the conveyor sub-system 30′ further comprises a support 38′ which extends or is extendable between the movable carriages 32b of a pair.

The support 38′ may include a slat or bar. The support 38′ is associated with at least one movable carriage 32b′. Optionally, each movable carriage 32b′ of a pair may comprise a portion of the support 28′. The portions may optionally be engageable together. For example, one portion may be receivable in, on, or around an otherwise free end of the other portion. The supports 38′ of consecutive pairs of movable carriage 32b generally provide together a surface or substantially a surface upon which to place an item. In other words, the conveyor sub-system 30′ is or is substantially a flat bed.

A longitudinal extent of the support 38′ may be adjustable. For example, one portion may be engageable with the other portion in a range of positions. The support may be telescopic. This may facilitate moving around corners. Additionally or alternatively, the adjustability of the longitudinal extent may accommodate an uneven or variable spacing between guiding portions 32a′. To further facilitate the movement of a pair of movable carriages 32b′ around a corner, one or more further carriages 32b′ may be inserted or insertable into or onto one of the guiding portions 32a′ prior to movement along a corner. After the corner, the one or more further carriages 32b′ may optionally be removed from guiding portion 32a′.

Referring back to FIG. 2, the environmental buffering means 24e, also referred to as an environmental buffer, buffering portion or part, in-use provides a buffer against the environment. The environmental buffering means 24e includes at least one of: an insulating layer, a natural disaster protection means, sub-system or mechanism 40, and means for preventing or inhibiting contamination, any other element or part providing a buffer or protection against the environment, a plurality of any of the above, and any combination of the above.

If an insulating layer is provided, the insulating layer may be a gap provided between the shell structure 24a and the surrounding ground. The gap may be filled by any of: a vacuum, gel, liquid, insulation, any suitable material, and any combination thereof.

The natural disaster protection means 40, also referred to as a natural disaster protector or protective portion, or system, in-use prevents or inhibits damage to the farming and food-distribution system 10 or at least to the protective shell 16 due to natural disasters and/or extreme weather. The natural disaster protection means 40 may be referred to as natural disaster protection infrastructure, apparatus, assembly, sub-system, module or portion. The natural disaster protection means 40 may include any or any combination of flood-proofing means 42a, fire-proofing means, wind-redirecting element, land movement-proofing means 42b, and any other sub-system, mechanism or means for protecting against extreme weather and/or a natural disaster.

The flood-proofing means 42a may be referred to as a flood-proofing apparatus, assembly, sub-system, element, portion or module. The flood-proofing means 42a in-use prevents or inhibits at least partial flooding of the farming and food-distribution system. The flood-proofing means 42a may include any of: a sluice, a valve, a pump, a fluid-diverting element or part, a fluid-proof layer, fluid-proof paint, a fluid-proof or fluid-tight partition or wall, an absorbent material, a rain garden, any other flood barrier, a floatation system, an anchor, a plurality of any of the above, and any combination of the above.

At least one fluid-tight partition 44 may sub-divide the internal volume of the protective shell 16 into at least two fluid-tight chambers 46. The individual fluid-tight chambers 46 may be sealable or sealed. Thus, even if one chamber 46 is at least partly flooded, the other chamber or chambers 46 may be sealed off to prevent or inhibit food within from being destroyed by the flood. The sealable chambers 46 may be any shape and size. The sealable chambers 46 may be in any position relative to each other. For example, a fluid-tight partition 44 may be at least partly horizontal. This may define two chambers 46, one being at least in part overlying the other. This is illustrated in FIG. 2. Alternatively or additionally, a fluid-tight partition 44 may be at least partly vertical.

The shell structure 24a may optionally be fluid-proof or fluid-tight. This may enable the farming and food-distribution system 10 or at least the protective shell 16 to be partly or fully submerged, at least temporarily. The farming and food-distribution system 10 or at least the protective shell 16 may even be permanently submerged. If provided with a floatation system, the farming and food-distribution system 10 or at least the protective shell 16 may at least partly float, at least temporarily. The floatation system may comprise a buoyant portion, and/or a hull, such as a ship hull, by way of example only. Any alternative element enabling floatation may be provided. The shell structure 24a being fluid-tight may be enable the farming and food-distribution system 10 or at least the protective shell 16 to be positioned in an environment having a different atmosphere and/or in a vacuum, such as the vacuum of space.

The fire-proofing means or module may be referred to as a fire-proofing apparatus, assembly, sub-system, element, or portion. The fire-proofing means in-use prevents or inhibits the farming and food-distribution system being damaged or destroyed by fire. The fire may be external and/or internal. The fire-proofing means may include any of: fire retardant, a vacuum, a sprinkler, a fire-proof layer, fire-proof paint, a fire-proof or fire-tight partition or wall, non-flammable material, phase change material, any other fire barrier, a plurality of any of the above, and any combination of the above.

The wind-redirecting element or module in-use redirects wind to prevent or inhibit damage to the farming and food-distribution system 10 due to strong winds. High winds may be experienced during storms, hurricanes, cyclones, tornadoes, El Nino events, by way of example only.

The land movement-proofing means 42b may be referred to as a land movement-proofing apparatus, assembly, sub-system, element, module or portion. Land movement may occur for a variety of reasons, such as a landslide, a mudslide, an earthquake, and geological movements such as tectonic plates movement, by way of example only. As ice occupies a larger volume than water, freezing and thawing of water around the farming and food-distribution system 10 and/or the protective shell 16 may result in contraction and expansion of the ground and/or water surrounding the farming and food-distribution system 10 and/or the protective shell 16. The land movement-proofing means 42b may include at least one of: a cage element or cage, a flexible foundation, a damping element or damper, a vibration-controlling element or controller, a reinforcing element or reinforcement, an earthquake-resistant material, a compressible and/or expandable layer, material, element or portion. The damping element may include a shock absorber and/or a pendulum system. The vibration-controlling element or portion may redirect energy of an earthquake around the protective shell 16. The vibration-controlling element or portion may include one or more concentric rings, and more preferably concentric plastic and/or concrete rings. A reinforcing element may include any of: a shear wall, a cross-brace, a horizontal frame which redistributes forces, and a moment-resisting frame, a plurality of any of the above, and any combination of the above.

Although separate features are provided against separate categories of disasters above, it is understood that one feature may provide protection against a plurality of categories of disasters. For example, a fire door may also be fluid-tight such that the fire door may provide protection against both fire and flooding.

Means for preventing or inhibiting contamination, also referred to as an anti-contamination part, portion or mechanism, in-use prevent or inhibit contamination of the internal volume of the system 10 by contaminants and/or pathogens from the exterior environment and/or of the exterior environment by contaminants and/or pathogens from the system 10. The risk of biological weapons may also be reduced. Additionally or alternatively, means for preventing or inhibiting contamination may in-use prevent or inhibit cross-contamination within the system. Means for preventing or inhibiting contamination may be referred to as a contamination shield or barrier, containment infrastructure, or anti-contamination module, infrastructure, or sub-assembly. Contamination may be by a biological contaminant and/or a non-biological contaminant. For example, preventing or inhibiting the spread of diseases and/or pests may be desirable. This may enable fewer to no biocidal substances to be used, such as pesticides, or virucides. If plants and/or animals are genetically modified or edited, preventing or inhibiting gene flow between any of: different individuals, populations, varieties, and species may be desirable. Non-biological agents may include mineral matter, or any other non-biological foreign object.

Means for preventing or inhibiting contamination may comprising at least one of: a disinfection zone, an airlock, a partitioning wall, netting, a vacuum, a pollen-trapping element or pollen trap, a pollen-destroying element or part, a pathogen trap, a pathogen destruction element or part, an air-moving element or device, a suction element or part, a high-pressure zone, an autoclave, any other suitable method of preventing or inhibiting ingress or egress of biological and/or non-biological matter from one volume to another volume, a plurality of any of the above, and any combination thereof.

Food-producing infrastructure 18 in-use enables food production. The food-producing infrastructure 18 is preferably located within the protective shell 16. Food-producing infrastructure 18 includes a plant-growing support 48a, a lighting sub-system 48b, a temperature-control sub-system 48c, a fluid-distribution sub-system 48d, a growth-monitoring element or growth monitor 48e, a food harvesting element or food harvester 48f, a pollination sub-system 48g, an animal support 48 h, and an aquatic-body access conduit 48i, but any of the above may be omitted and/or a plurality of any of the above may be provided. Optionally, the plant-growing support 48a and the animal support 48h, jointly or individually, may be referred to as a product-growing support. Preferably, food comprises at least one, and more preferably, a plurality of plants. The plants are preferably at least in part edible. Plants may including fruiting trees, bushes, crops, leafy greens, baby greens, microgreens. Fruit, vegetables and/or cereals may be grown. Additionally or alternatively, the food may comprise one or more animals. The plants and/or animals may be of the same species and same variety or breed, but preferably, a range of species and/or a range of varieties or breeds are grown.

The plant-growing support 48a in-use supports and enables the growth of at least one plant. In the present embodiment, the plant-growing support 48a includes a growth medium 50a, a container 50b and a frame 50c, although any of these may be omitted and/or a plurality of any of these may be provided.

The growth medium 50a may include any of: soil, earth, compost, fluid, such as water, foam, matting, moss, fibres, such as carpet fibres, any other suitable medium enabling growth, a plurality of any of the above, and any combination thereof.

The container 50b in-use supports and/or contains the growth medium 50a and/or at least one plant. The container 50b may be of any desirable shape and/or form as long as it can fulfil its function. For example, the container 50b may include any of: a tray, a conduit, a plate, a bowl, a shelf or shelf element, or any other suitable containing portion, a plurality of any of above, and any combination thereof. The container 50b may be moved using magnets beneath the floor membrane, or could be formed so as to aquaplane across a water layer to thereby reduce friction during transit.

The frame 50c in-use receives, holds or supports the container 50b and/or growth medium 50a. The frame 50c may in-use enable plants to be suspended or grown in a high position so as to be able to hang and grow downwards, but this is optional. Alternatively or additionally, the frame 50c may provide a support for climbing and/or trailing plants. For example, plants such as tomatoes, or fruit crops may be climbers and/or may typically require a support to grow upwards. For ease of harvest, one or more of said plants may optionally be grown in a high position and/or be trained to trail or grown downwards. Preferably, the frame 50c may receive a plurality of containers 50b, but this is optional. At least two containers 50b may be adjacent each other. Two or more containers 50b may even be co-planar or substantially co-planar. The frame 50c may optionally enable at least one container 50b to overlie, overlap or be above another said container 50b. In other words, a plurality of containers 50b may be stackable and/or vertically above one another. Thus, the frame 50c may enable vertical farming. Preferably, the frame 50c may vertically space apart a container 50b on a, notionally first, level from a container 50b on a notionally second level by a distance. If the frame 50c has a greater number of levels, the distance may be the same between all pairs of levels, but this is optional. For example, the distance between the notionally first and second levels may differ from the distance between the notionally second and the third levels. The distance between levels of the frame 50c may even be adjustable. For a more efficient use of space, the distance may be selected to correspond to or substantially correspond to a height of the plant species to be grown. The height may be the maximum height and/or a target height at which the plant may be harvested. Alternatively, the distance may be changing as the plant grows. The changes in distance may be continuous and/or incremental, whether regular or irregular increments. The frame 50c may optionally comprise an actuation mechanism to move the levels apart by way of example.

The lighting sub-system 48b in-use emits light, preferably artificial light. The lighting sub-system 48b includes at least one light or light-emitting element. Preferably, the lighting sub-system 48b may further comprise at least one solar panel 52 for capturing solar energy. The light is preferably directed towards the container 50b and/or growth medium 50a. This enables any plants growing within to photosynthesise. The lighting sub-system 48b or the at least one light-emitting part or element thereof is preferably positioned or positionable at or adjacent the plant-growing support 48a. If several levels are provided, a light-emitting element may be provided to illuminate one, all or a plurality of levels. The or each light-emitting element may be positioned above a plant and below a level of the frame 50c. If the growth medium is either omitted, or is at least partly transparent or translucent, and the frame 50c or part thereof and/or the container 50b is at least partly transparent or translucent, a greater amount of light may reach an individual plant. This may enhance the growth rate and/or may enable fewer light-emitting elements to be used to achieve the same amount of illumination. To further increase the farming efficiency and/or enhance the growth of the plants, the artificial light emitted may be restricted to a reduced spectrum of wavelengths or even a single wavelength.

The or each light-emitting part or element preferably includes one or more LEDs but any non-LED may be envisioned.

Optionally, at least one said solar panel 52 may comprise a perovskite structure. A perovskite structure designates a compound from a class of compounds which have the same or similar crystal structure to CaTiO3. More preferably still, at least one said solar panel 52 may include perovskite, also referred to as a calcium titanium oxide mineral or calcium titanate. Cations may be embedded or embeddable into this structure to provide different properties. A perovskite structure and/or calcium titanate may enable the solar panel to have a higher yield than a silicone photovoltaic cell.

The temperature-control sub-system 48c in-use enables the temperature of the internal volume and/or any chamber 46 to be altered. Due to be being underground, the temperature of within the internal volume is generally constant or more constant than a corresponding building above ground. In other words, the internal volume is less exposed or not exposed to thermal fluctuations, for example due to the weather, daily cycles, and/or seasons. However, heat may still be lost to or gained from the surrounding ground and/or to or from the distribution centre 12a. Thus, the temperature-control sub-system 48c enables cooling and/or heating of the internal volume and/or any chamber 46 thereof. The temperature of different chambers 46 may even be independently controllable. The temperature may be selectable, as growth of an organism may be optimal at said specific temperature. Different species may have different specific temperatures. The specific temperature may be constant throughout the whole lifecycle of an organism, but variable may be an option. For example, it may be desirable to replicate temperature fluctuations over a given time period. The period may be a day, a month, a season, or a year, by way of example only. Different stages of a lifecycle may require different temperatures for optimal growth. For example, cooling or vernalisation may be required for a plant to germinate and/or flower.

The temperature-control sub-system 48c includes a heat pump, not shown, but any alternative to a heat pump may be envisioned. For example, geothermal, a water-heating solar panel or any standard heater and/or cooling mechanism may be additional or alternatives to a heat pump. The heat pump may be a ground-source heat pump and/or an air-source heat pump.

The animal support 48h in-use enables animals to be stored at least temporarily. Optionally, the animal support 48h may in-use enable animals to be reared. The animal support 48h be configured for supporting land-based or terrestrial life and/or aquatic life. The animal support 48h may include a terrestrial life support 54a and an aquatic life support 54b.

The terrestrial life support 54a may enable land-based species to be stored and/or reared. Land-based species may include cattle, pigs, birds, such as chickens, and rabbits by way of example only. The terrestrial life support 54a may include at least one animal enclosure. The animal enclosure may be any of: a pen, a container, a field, any other suitable enclosure, a plurality of any of the above, and any combination of the above.

The aquatic life support 54b may enable aquatic species to be stored and/or reared. The aquatic life may include but not be limited to: fish, aquatic mammals, crustaceans, corals, sponges, and oysters. Aquatic plants, such as algae, may optionally be grown in the aquatic life support 54b. Preferably, the aquatic life support 54b may include at least fluid-storage chamber. Said fluid-storage chamber preferably includes at least one tank. The fluid may be a liquid, such as water. The aquatic-body access conduit 48i in-use fluidly connects the aquatic life support 54 b and/or the tank thereof to a body of water 56. The body of water 56 may include a lake or the sea, by way of example. The aquatic-body access conduit 48i enables aquatic life from the body of water 56 to move or be moved from the body of water 56 towards or into the aquatic life support 54b. The aquatic-body access conduit 48i may additionally or alternatively allow water into the aquatic life support 54b from the body of water 56 and/or vice-versa. The aquatic-body access conduit 48i comprises a duct or duct element. Optionally, the aquatic-body access conduit 48i and/or the aquatic life support 54b may further comprise a bait and/or a trap 58.

The bait in-use attracts aquatic life into the aquatic life support 54b and/or aquatic-body access conduit 48i. The bait may comprise any of: a chemical attractant, a visual bait, an auditory bait, an animal or part thereof, any other baiting element or bait, and any combination thereof.

The trap 58 may in-use prevent or inhibit aquatic life from moving along the aquatic-body access conduit 48i in the direction of the body of water from the aquatic life support 54 b. The trap 58 may include any of: netting, a flap, a valve, a suction element or mechanism, a jet, any other suitable trapping element or mechanism or trap, a plurality of any of the above, and any combination thereof.

Referring to FIG. 5, the fluid-distribution sub-system 48d in-use enables fluid to be distributed to the plant-growing support 48a. The fluid is preferably a liquid but part liquid or non-liquid, such as gas may be an option. The fluid preferably includes water. Optionally, the fluid may comprise nutrients and/or growth enhancing elements, also referred to as a growth enhancer, such as hormones. Thus, the fluid-distribution sub-system 48d in-use enables feeding and/or watering of plants. The fluid-distribution sub-system 48d enables plants to be grown via aeroponics, hydroponics, aquaponics, or any combination thereof. The fluid-distribution sub-system 48d comprises a fluid-storage chamber 60a, at least one fluid conduit 60b, pumping means 60c, an external-fluid capturing element 60d, and a fluid purification means 60e, but any of the above features may be omitted and/or a plurality of any of the above features may be provided.

The fluid-distribution sub-system 48d may be an open loop sub-system or, preferably, a closed loop sub-system. The term “closed loop sub-system” used herein and throughout is intended to mean that fluid circulates from the fluid-storage chamber 60a, through the at least one fluid conduit 60b before returning to the fluid-storage chamber 60a. It is understood that as plants uptake fluid from the fluid-distribution sub-system 48d to grow and/or photosynthesise, there may be a net loss of fluid when plants are removed from the food-producing infrastructure 18. Thus, the closed loop sub-system may be substantially closed loop. For clarity, the term “closed loop sub-system” is intended to cover both completely closed loop and substantially closed loop sub-systems.

The fluid-storage chamber 60a, also referred to as a fluid storage, in-use stores fluid. The fluid-storage chamber 60a preferably includes at least one fluid container 50b. The or each fluid container 50b may be a tank. The at least one fluid container 50b may be placed anywhere suitable in relation to the plant-growing support 48a. For instance, at least one said fluid containers 50b may be vertically overlapping or non-vertically overlapping with the plant-growing support 48a. An upper part of at least one said fluid containers 50b may extend to or may be any of: at least partly below, at least partly above, and level with the plant-growing support 48a. Similarly, a lower part of least one said fluid containers 50b may extend to or may be any of: at least partly below, at least partly above, and level with the plant-growing support 48a. Preferably, the, each or at least one said fluid containers 50b surrounds the plant-growing support 48a. The or each fluid-storage chamber 60a of the fluid-distribution sub-system 48d may be completely independent of the aquatic life support 54b. However, it is preferred that fluid-storage chamber 60a of the fluid-distribution sub-system 48d is the same as the fluid-storage chamber of the aquatic life support 54b. This enables the space to be more efficiently used. The tank may be an aquaculture tank. In other words, the same tank may be enable storing and/or rearing of aquatic life, as well as storing fluid. Excretions from the aquatic life may beneficially contain nutrients and/or growth enhancing elements. Thus, fluid containing the excretions may be used to water and feed the plants. In other words, the aquaculture tank enables the provision of an aquaponic and/or aeroponic food-producing infrastructure.

The at least one fluid conduit 60b in-use provides a conduit, duct or pipe for the fluid. The, each or at least one fluid conduit 60b is associated at least in part with the plant-growing support 48a. The, each or at least one fluid conduit 60b is preferably positioned in, on, at, through or adjacent the plant-growing support 48a so that plants may uptake fluid from the fluid conduit 60b. Thus, at least one fluid conduit 60b preferably connects the fluid-storage chamber 60a to the plant-growing support 48a for providing fluid thereto. If a plurality of fluid conduits 60b are provided, they may be connected in series and/or in parallel, as required.

The pumping means 60c in-use pumps the fluid through the fluid-distribution sub-system 48d. The pumping means 60c may also be referred to as a pumping element, mechanism, or a pump device. The pumping means 60c may include at least a pump. It may easily be envisioned that the pumping means may be omitted. For example, in an alternative embodiment, fluid may flow through the at least one fluid conduit under gravity. The fluid-storage chamber may even be positioned in a high position relative to the plant-growing support. A syphon or capillary system may be further alternatives.

The external-fluid capturing element or part 60d in-use enables the capture and optionally storage of fluid outside of the farming and food-distribution system 10. The external-fluid may be captured from any of: rain, floodwater, underground water, river water, lake water, saltwater, water from any other aquatic body, condensation, any other suitable source of water, and any combination of the above.

The fluid purification means 60e in-use purifies the fluid to remove undesirable substances. The fluid purification means, element or fluid purifier 60e may include a filter and/or at least one chemical. The fluid purification means 60e may remove undesirable substances from any of: the fluid-storage chamber 60a, the at least one fluid conduit 60b, the pumping means 60c, the external-fluid capturing element 60d, or any combination thereof. The fluid purification means 60e may optionally include a water desalination means for desalinating saltwater, also referred to as a desalinator.

The growth-monitoring element 48e, also known as a growth-monitor, in-use enables monitoring of the growth of one or more plants and/or of the growth of the aquatic life. The growth-monitoring element 48e may include any of: a camera, weighing scales, artificial intelligence, any alternative means, mechanism or system that can detect the stage of lifecycle, weight and/or height of a plant or animal, a plurality of any of the above, and any combination thereof.

The automated food harvesting element 48f, also referred to as a harvester, in-use enables automatic harvesting of food. The food harvesting element 48f may include at least one robotic device and/or at least one robotic arm, by way of example. Any other suitable automated food harvesting element may be envisioned.

The pollination sub-system 48g in-use enables and/or increases the likelihood of pollination. The pollination sub-system 48g includes a pollinator-housing means, an air-moving means 62, and honey producing infrastructure, but any of the above features may be omitted and/or a plurality of any of the features may be provided.

The pollinator-housing means, also referred to as pollinator-housing or pollinator-receiving element, in-use receives and supports at least one pollinator. The pollinator-housing means may include a nest, a housing, a frame, any other suitable device, a plurality of any of the above. The pollinator may be any of: one or more insects from at least one species, one or more birds from at least one species, one or more bats from at least one species, or any combination thereof. This may increase biodiversity and/or enable pollination of insect-, bird-and/or bat-pollinated crops. For example, the species may include a species of bees. The pollinator-housing means may include a hive or at least a frame for a hive, by way of example.

The air-moving means 62, also referred to as an air-moving element, mechanism, device or portion, enables air to be moved. This may be useful to enable pollen to be moved for pollination of wind-pollinated plants. The air-moving means 62 may include a fan and/or a suction device, by way of example.

The honey producing infrastructure or honey harvesting infrastructure may enable honey to be produced and/or harvested. Preferably, the honey producing infrastructure may include a hive or housing for receiving honey-producing insects such as bees. Optionally, the pollinator housing means and the honey producing infrastructure may be one and the same.

Infrastructure for genetically altering an organism, such as an underground laboratory, may enable genetic manipulation to be carried out. Infrastructure for genetically altering an organism may be referred to as a genetic manipulation module, or sub-assembly. Genetically altering or manipulating may include one or more of: genetic editing, genetic modification, and any other technique for altering genetic material of an organism. The genetic manipulation may have any of the following purposes: research, improve yields, improve nutritional qualities, breed pathogen and/or pest resistance, produce a pharmaceutical compound, any other suitable purpose, or any combination thereof. For example, genetic editing or genetic modification to produce dwarf varieties of crops, such as maize or wheat, may enable a plant's resources to be re-allocated to the part of the plant which is harvested as produce, such as the root, fruit, leaf, or flower instead. This may result in greater yields per plant. Additionally, a dwarf variety may take up a smaller volume of the food-producing infrastructure. As such, if a vertical farming and food-distribution system is used, a greater number of plants may be grown in a given volume.

The pharmaceutical-production infrastructure 20 in-use enables the production of pharmaceutical substances. The term “pharmaceutical substance” used herein and throughout is intended to mean a substance, compound or chemical which is used in the preparation of a medicament. The medicament may be for treating and/or preventing a disease. The medicament may be a vaccine. Preferably, the pharmaceutical-production infrastructure 20 enables at least one organism to be grown, the organism producing at least one said pharmaceutical substance. The organism is preferably a plant, but any alternative, such as an animal, or even a single celled organism, such as yeast may be used. The organism may produce the pharmaceutical substance ordinarily. Alternatively or additionally, the plant may be inoculated and/or genetically altered to produce the pharmaceutical substance. The pharmaceutical-production infrastructure 20 may be otherwise similar or identical to the food-production infrastructure 18. Detailed description of the common feature is omitted for brevity. It may even be envisioned that the pharmaceutical-production infrastructure and the food-production infrastructure may share some or all the above-described features of the food-production infrastructure. In other words, the food-producing infrastructure 18 may be a hybrid food and pharmaceuticals-production infrastructure. For example, at least one plant producing one or more pharmaceutical substances may be grown alongside an edible plant in the plant-growing support 48a. The substance may be extracted and/or purified from the plant. Alternatively, the edible plant may also produce the substance such that eating the plant provides both food and medication simultaneously. An example of such a plant may include Golden rice. Golden rice has been genetically engineered to provide beta carotene, a pre-cursor of vitamin A, to curb or prevent dietary deficiencies in vitamin A. Optionally, the pharmaceutical-production infrastructure 20 may comprise a vaccine-production infrastructure 64, but this may be omitted, or a plurality may be provided.

The vaccine-production infrastructure 64 in-use enables the production of vaccines. Preferably the vaccine-production infrastructure 64 enables the creation and/or growth of plants inoculated or genetically modified to produce at least one pharmaceutical substance for a vaccine against a disease. Preferably, the disease is a non-plant disease, but a plant disease may be envisioned. Even more preferably, the disease is a human disease.

In-use, the farming and food-distribution system 10 needs to be installed. The system 10 may optionally be provided as a kit of parts. A cavity or hole 66 in the ground is created, as shown in FIG. 6. Material excavated from the cavity 66 can be loose or rubble. Preferably however, the material is cut out or removed in a workable and/or easily transportable form, such as a slab. Slabs, for example, slabs of limestone or other hard rock, may then be re-employed for further purpose. A building adapted for growing food underground, which is preferably the protective shell 16, is created and positioned in the cavity 66. The protective shell 16 is preferably formed at least in part of concrete or cement, and more preferably of reinforced concrete. In the preferred embodiment, a reinforcement frame 68 is positioned in the cavity 66. A building material is then inserted on or in the frame 68, preferably by spraying as shown in FIG. 6. The building material is preferably cement and/or concrete, but any alternative, such as fibre glass, foam, or metal may be options. Bricks, breezeblocks, wood may be further alternatives. The protective shell 16 is preferably dimensioned and/or sized such that once the assembly is completed, the shell is at least partly, and more preferably fully recessed relative to the ground surface.

In an alternative embodiment, It may easily be envisioned that the shell of the building may be at least partly formed prior to insertion into the cavity.

Optionally, a secondary lining 24b is provided in or on the walls of the protective shell 16, preferably an inner surface thereof. The secondary lining 24b may be fluid proof, waterproof, fluid tight, or watertight. This may be particularly beneficial for aquaponics.

The food-producing infrastructure 18 and/or the pharmaceutical-production infrastructure 20 are installed in the protective shell 16 for providing at least part of the below-surface assembly 14 for underground farming.

The above-surface assembly 12 may be created prior to, during and/or after the formation of the cavity 66 and/or the below-surface assembly 14. The above-surface assembly 12 or at least the above-surface distribution centre 12a is preferably created at or adjacent the below-surface assembly 14, and more preferably on the below-surface assembly 14. Thus, there is disclosed a method for local bespoke installation of the below-surface assembly 14 for underground farming in conjunction with an above-surface distribution centre 12a.

The food-producing infrastructure 18 may already be fully or at least partly assembled prior to installation in the protective shell 16. If not fully assembled, the user may carry out any or all the following steps, not necessarily in the following order.

The plant-growing support 48a is set up so as to enable at least one plant to be received therein. The lighting sub-system 48b is assembled and arranged so that the light emitting element thereof is able to shine light onto or adjacent to the at least one plant. The at least one fluid conduit 60b of the fluid-distribution sub-system 48d is connected to fluid-storage chamber and the plant-growing support 48a. The temperature-control sub-system 48c is connected or assembled so as to control the temperature of the plant-growing support 48a. The pollination sub-system 48g is provided at or adjacent the plant-growing support 48a, or is connected therewith to provide access for the pollinators to the at least one plant. The growth-monitoring element 48e is set up and configured to be able to monitor the growth of the at least one plant. The food harvesting element 48f is set up and configured to be able to pick or harvest the at least one plant preferably once it is ready to be harvested.

If the infrastructure for genetically altering an organism and/or a pharmaceutical-production infrastructure 20 distinct from the food-producing infrastructure 18 is provided, the same steps or similar steps are followed to assemble the pharmaceutical-production infrastructure 20. Detailed description of the common features is omitted for brevity. Once the farming and food-distribution system 10 is assembled, it may be used to produce food and/or medicine. It may easily be envisioned that the distribution centre may be partly or fully open air in an alternative embodiment to an enclosed distribution building.

Whilst the cavity is preferably created for the sole purpose of receiving at least part of the farming and food-distribution system, it may easily be that an existing building, structure or cavity may be repurposed. Non-limiting examples of repurposed buildings or cavities may include a bunker, an underground rail network or underground train stop.

The farming and food-distribution system is preferably installed on planet Earth. However, it may easily be envisioned that the farming and food-distribution system may be installed and used on another celestial body, such as the Moon, or Mars, by way of example.

In an alternative embodiment, in addition or as an alternative to a distribution centre, the above-surface assembly may include any of: a lift, commercial infrastructure, residential infrastructure, parking, any other suitable infrastructure, and any combination thereof. Residential infrastructure may include a flat, a house or villa, or a plurality of any of the above. Commercial infrastructure may include an office and/or a shop, or a plurality of either.

Whilst the system is preferably designed for the purpose of producing food and/or pharmaceutical compounds, the system may optionally also provide a structure to receive and support species, and more preferably endangered species. Thus, the system may further include a zoo or zoo assembly. The zoo assembly may preserve or increase biodiversity. Indeed, the system may be provided as an ark having underground chambers in which endangered species of flora and fauna can be housed and nurtured, to ensure that they can multiply. Embryos could be stored in lieu of fully grown animals. Whilst a preferred shape may have been specified for any of the above-described, any alternative shape may be envisioned in any of lateral or cross-section, longitudinal cross-section, in side view, in plan view. The shape may be any or any combination of: curved, part curved, non-curved, linear, part linear, non-linear, a broken line, any polygon, whether regular or irregular, having one or more chamfered and/or rounded corners, a triangle, a quadrilateral, such as a square, a rectangle, a trapezium, a trapezoid, a pentagon, a hexagon, a heptagon, an octagon, or any other polygon, a cross, an ellipse, a circle, part circular, an oval, or any abstract shape.

It is therefore possible to provide a vertically-integrated combined farming and food-distribution system which enables the production and distribution of food which is grown and/or raised, preferably wholly, beneath a ground surface and/or beneath a surface of a body of water. This arrangement improves food security by sheltering at least in part the infrastructure for producing food from the elements. To enable this, the system has a below-surface food-production assembly for producing food and having: a protective shell which is locatable at least partly below the surface; food-producing infrastructure positioned within the protective shell for growing or raising an edible product. An above-surface distribution centre for distributing the food produced by the below-surface food-production assembly, the above-surface distribution centre overlying or overlapping the below-surface food-production assembly which provides a foundation therefor; and an access between the below-surface food-production assembly and the above-surface distribution centre for allowing the movement of the edible product therebetween. The vertical arrangement of the distribution centre above the assembly increases the land-usage efficiency. The distribution centre above ground could include a lift section wherein the building can be loaded below ground and moved hydraulically or electrically to the surface. A stronger roof can then cover the underground distribution centre for security. This may improve the resistance to inclement environmental conditions, such as hurricanes, or severe storms. This also reduces the risk of theft. The distribution centre could be a pre-fabricated unit and may not need solid walls. The roof could include solar panels. Alternatively, the distribution centre could be provided as a marquee or similar canvas structure. It is therefore also possible to provide a method which simultaneously improves land-usage efficiency, increases food freshness and/or reduces pollution due to transport of food of vertical and/or horizontal distances. The method involves creating or repurposing a cavity in the ground; before positioning in the cavity a protective shell which receives food-producing infrastructure. Above the below-surface food-production assembly is provided an above-surface distribution centre vertically overlying the below-surface food-production assembly and communicable with the below-surface assembly for minimising time and distance travelled by food produced by the below-surface food-production assembly.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof. It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A vertically-integrated combined farming and food-distribution system (10) for producing and distributing food which is grown and/or raised wholly beneath a surface of ground and/or of a body of water (56), the system (10) comprising:
a below-surface food-production assembly (14) for producing food and having:
a protective shell (16) which is locatable at least partly below the surface;
food-producing infrastructure (18) positioned within the protective shell (16) for growing or raising an edible product, the food-producing infrastructure (18) including:
a product-growing support (48a,48h) for supporting and enabling the growth of the edible product thereat,
an artificial lighting sub-system (48b) positionable at or adjacent the product-growing support (48a,48h) for illuminating the edible product, and
a fluid-distribution sub-system (48d) having a fluid-storage chamber (46), and at least one fluid conduit (60b) connecting the fluid-storage chamber (46) to the product-growing support (48a,48h) for providing fluid thereto; and
an above-surface distribution centre (12a) for distributing the food produced by the below-surface food-production assembly (14), the above-surface distribution centre (12a) overlying the below-surface food-production assembly (14) which provides a foundation therefor; and
an access (29) between the below-surface food-production assembly (14) and the above-surface distribution centre (12a) for allowing the movement of the edible product therebetween.

2. A system (10) as claimed in claim 1, wherein the protective shell (16) and/or the above-surface distribution centre (12a) further comprises a roof (24c), at least part of the roof (24c) being moveable between an open condition and a closed condition, for facilitating the access (29) to an internal space of the protective shell (16) and/or the above-surface distribution centre (12a).

3. A system (10) as claimed in claim 1 or claim 2, wherein the fluid-storage chamber (46) includes an aquaculture fluid-storage chamber (46) for storing fluid as well as supporting aquatic life therein for providing an aquaponic food-producing infrastructure (18).

4. A system (10) as claimed in any one of the preceding claims, further comprising at least one solar panel (52) for capturing solar energy to power the farming and food-distribution system (10), wherein at least one said solar panel (52) optionally comprises a perovskite structure.

5. A system (10) as claimed in any one of the preceding claims, further comprising food-moving infrastructure (24d) which includes at least one of: a lift and a conveyor sub-system (30; 30′).

6. A system (10) as claimed in claim 5, wherein the conveyor sub-system (30; 30′) includes a guiding portion (32a; 32a′) and a plurality of movable carriages (32b; 32b′) which are moveable under compression along the guiding portion (32a; 32a′).

7. A system (10) as claimed in claim 6, wherein at least one of the movable carriages (32b; 32b′) includes an identifier (36c) for enabling a movable carriage (32b; 32b′), and any item associated therewith, to be trackable.

8. A system (10) as claimed in any one of the preceding claims, further comprising a heat pump.

9. A system (10) as claimed in any one of the preceding claims, further comprising water desalination means for desalinating salt water.

10. A system (10) as claimed in any one of the preceding claims, wherein the below-surface food-production assembly (14) further comprises infrastructure for genetically altering an organism.

11. A system (10) as claimed in claim 10, wherein the infrastructure for genetically altering an organism further comprises vaccine-production infrastructure (64) for creating and growing plants inoculated to produce a substance for a vaccine against a non-plant disease.

12. A system (10) as claimed in any one of the preceding claims, further comprising an automated food harvesting element (48f) for automatically harvesting food and/or a growth-monitoring element (48e) for monitoring the growth of a plant and/or animal.

13. A system (10) as claimed in any one of the preceding claims, further comprising natural disaster protection means (40) for providing protection against extreme weather and/or a natural disaster.

14. A system (10) as claimed in claim 13, wherein the natural disaster protection means (40) includes flood-proofing means (42a) for preventing or inhibiting flooding of the farming and food-distribution system (10).

15. A system (10) as claimed in claim 13 or claim 14, wherein the natural disaster protection means (40) includes fire-proofing means for preventing or inhibiting fire in the farming and food-distribution system (10).

16. A system (10) as claimed in any one of claims 13 to 15, wherein the natural disaster protection means (40) includes a wind-redirecting element for redirecting wind to prevent or inhibit damage to the farming and food-distribution system (10) due to strong winds.

17. A system (10) as claimed in any one of claims 13 to 16, wherein the natural disaster protection means (40) includes land movement-proofing means (42b) for preventing or inhibiting damage to the farming and food-distribution system (10) due to land movements.

18. A system (10) as claimed in claim 17, wherein the land movement-proofing means (42b) including at least one of: a cage element, a flexible foundation, a damping element, a vibration-controlling element, a reinforcing element, and earthquake-resistant materials.

19. A system (10) as claimed in any one of the preceding claims, further comprising means for preventing or inhibiting contamination by a contaminant and/or pathogen of the below-surface food-production assembly (14) or part thereof.

20. A system (10) as claimed in claim 19, wherein the means for preventing or inhibiting contamination comprises at least one of: a disinfection zone, an airlock, a partitioning element (44), netting, a membrane, a vacuum, a pressurised chamber, a pathogen destroying element, a pathogen capturing element, a pollen-trapping element, a pollen-destroying element, and an air-moving element (62) for preventing or inhibiting genetic contamination of the edible product.

21. A system (10) as claimed in any one of the preceding claims, wherein the below-surface food-production assembly (14) further comprises a pollination sub-system (48g) for enabling pollination of the plant.

22. A system (10) as claimed in any one of the preceding claims, wherein the vertically-integrated combined farming and food-distribution system (10) is provided as a kit of parts.

23. A method for simultaneously increasing food freshness and reducing pollution due to transport by reducing a distance travelable by food from a food-production site to a food-distribution centre, the method comprising the steps of:
a] creating or repurposing a cavity (66) in the ground and/or in a body of water;
b] creating and positioning in the cavity (66) a protective shell (16) and installing food-producing infrastructure (18) in the protective shell (16) for providing a below-surface food-production assembly (14) for producing food below a surface of the ground and/or of the body of water (56); and
c] creating an above-surface distribution centre (12a) overlying the below-surface food-production assembly (14) and communicable with the below-surface food-production assembly (14) for minimising time and distance travelled by food produced by the below-surface food-production assembly (14).

24. A method as claimed in claim 23, wherein in step b], the protective shell (16) is created by positioning a frame (68) in the cavity (66) and spraying a building material onto and/or into the frame (68).

25. A method as claimed in claim 23, wherein in step b], the protective shell (16) is formed prior to insertion into the cavity (66).
